(19) United States
(12) Patent Application Publication
(10) Pub. No.: US 2017/0023708 A1
(43) Pub. Date: Jan. 26, 2017

(54) INTEGRATED IMAGE DISPLAY, METHOD FOR MANUFACTURING SAME, AND SYSTEM INCLUDING SAME

(71) Applicant: SAMSUNG ELECTRONICS CO., LTD., Suwon-si (KR)

(72) Inventors: Mingcai ZHOU, Beijing (CN); Haitao WANG, Beijing (CN); Shaohui JIAO, Beijing (CN); Tao HONG, Beijing (CN); Weiming LI, Beijing (CN); Xiying WANG, Beijing (CN); Dong Kyung NAM, Suwon-si (KR)

(73) Assignee: SAMSUNG ELECTRONICS CO., LTD., Suwon-si (KR)

(21) Appl. No.: 15/124,940

(22) PCT Filed: Feb. 27, 2015
(86) PCT No.: PCT/KR2015/001901

§ 371 Date: Sep. 9, 2016

(30) Foreign Application Priority Data
Mar. 11, 2014 (CN) 201410088284.4
Aug. 26, 2014 (KR) 10-2014-0111355

(51) Int. Cl. G02B 3/00; H04N 13/04; G02B 27/22

(52) U.S. Cl. CPC G02B 3/0056; G02B 3/0062; G02B 3/0012; G02B 27/2214; H04N 13/0422; H04N 13/0404; H04N 2213/001

(57) ABSTRACT

An integrated image display, a method for operating the display, and a system including the display are provided. The integrated image display includes: a display panel including pixels; and a first lens array including a plurality of lenses, wherein each of the plurality of lenses is capable of displaying, in a beam direction, a subset of a plurality of subpixels included in at least one pixel from among the included pixels.

### CROSS-REFERENCE TO RELATED APPLICATIONS

This application is a national stage entry of International Application No. PCT/KR2015/001901, filed Feb. 27, 2015, which claims priority from Chinese Patent Application No. 201410088284.4, filed Mar. 11, 2014 in the State Intellectual Property Office of the People's Republic of China, and from Korean Patent Application No. 10-2014-0111355 filed Aug. 26, 2014 in the Korean Intellectual Property Office, the disclosures of which are incorporated herein by reference in their respective entireties.

### TECHNICAL FIELD

Exemplary embodiments relate to an integral image display (IID), a method for manufacturing the same, and a system including the same.

### BACKGROUND

With the development of scientific technology, black and white display technology developed into color display technology and two-dimensional (2D) display technology developed into three-dimensional (3D) display technology, following a desire to maximize user experience. 3D display technology includes a 3D display utilizing a parallax barrier, a hologram display, and volume rendering. A 3D display may be classified as a display method and an integral imaging display (IID) method using a parallax barrier. An IID method enables a user to directly view a 3D image having a relatively high level of brightness.

In an IID including a liquid crystal display (LCD) panel and a lens array, the LCD panel may display an elementary image array (EIA) image as a 2D image, and the lens array may generate a 3D image by refracting different portions of the EIA image in different directions in a 3D space.

Performance of the IID may be associated with a spatial resolution, an angular resolution, a visual angle, and a 3D depth range to be displayed.

### SUMMARY

One or more example embodiments provide technology that enhances a spatial resolution of an integral imaging display (IID) and maintains an angular resolution of the IID.

One or more example embodiments also provide an IID for which thickness is decreased.

One or more example embodiments also provide an IID for which a black moiré pattern is effectively decreased.

According to exemplary embodiments, there is provided an integrated image display (IID), the display including a display panel including pixels, and a first lens array including a plurality of lenses, wherein each of the lenses displays, in a ray direction, a subset of a plurality of subpixels included in at least one pixel among the pixels.

Each of the lenses may display, in the ray direction, at least one subpixel among the subpixels.

Each of neighboring lenses among the lenses may display subpixels included in a pixel among the pixels, and a number of the neighboring lenses is equal to a number of the subpixels included in the pixel.

The display panel may be disposed within a preset range of a focal plane of the lenses.

Colors of the subpixels displayed by each of the neighboring lenses may be different.

The subpixels may be arranged based on a standard red-green-blue (RGB) method.

The subpixels may be arranged based on a standard PenTile method.

The subpixels may be arranged based on a diamond PenTile method.

Lenses in two neighboring rows among the lenses may be arranged based on an interlace method.

Lenses in two neighboring rows among the lenses may be arranged in parallel.

The neighboring lenses may include at least one of neighboring lenses in a same row or neighboring lenses in another row.

The IID may further include a second lens array including a plurality of lenses, wherein the second lens array may be disposed in front of the first lens array or disposed between the first lens array and the display panel, and the second lens array may be rotated by 90 degrees with respect to the first lens array.

Rays emitted from neighboring lenses among the lenses may be converged to form a full color dot.

A distance between adjacent pairs of lenses included in the second lens array may be smaller than a distance between adjacent pairs of lenses included in the first lens array.

According to exemplary embodiments, there is provided a method of manufacturing an integrated image display (IID), the method including forming pixels included in a display panel, and forming a plurality of lenses such that each of the lenses included in a lens array displays, in a ray direction, a portion of a plurality of subpixels included in at least one pixel among the pixels.

Each of the lenses may display, in the ray direction, a subpixel among the subpixels.

Each of neighboring lenses among the lenses may display subpixels included in a pixel among the pixels.

A number of the neighboring lenses may be equal to a number of the subpixels included in the pixel.

Colors of the subpixels displayed by each of the neighboring lenses may be different.

The neighboring lenses may include at least one of neighboring lenses in a same row or neighboring lenses in another row.

### BRIEF DESCRIPTION OF DRAWINGS

The above and/or other aspects will become apparent and more readily appreciated from the following description of the embodiments, taken in conjunction with the accompanying drawings in which:

FIG. 1 is a diagram illustrating an example of a display system, according to an example embodiment;

FIG. 2 is a diagram illustrating an example of an integral imaging display (IID) illustrated in FIG. 1.

FIG. 3 is a diagram illustrating an example in which subpixels of a display panel illustrated in FIG. 2 are arranged based on a standard red-green-blue (RGB) method;

FIGS. 4 and 5 are diagrams illustrating examples in which lenses included in a lens array illustrated in FIG. 2 are arranged based on an interlace method;

FIG. 6 is a diagram illustrating an example in which lenses included in a lens array illustrated in FIG. 2 are arranged in parallel;

FIG. 7 is a diagram illustrating an example in which subpixels of a display panel illustrated in FIG. 2 are arranged based on a standard PenTile method;

FIG. 8 is a diagram illustrating an example in which lenses included in a lens array illustrated in FIG. 2 are arranged based on a standard PenTile method;

FIG. 9 is a diagram illustrating an example in which subpixels of a display panel illustrated in FIG. 2 are arranged based on a diamond PenTile method;

FIG. 10 is a diagram illustrating an example in which lenses included in a lens array illustrated in FIG. 2 are arranged based on a diamond PenTile method;

FIG. 11 is a flowchart illustrating an example of a method of manufacturing an integrated image display (IID) illustrated in FIG. 1; and

FIG. 12 is a diagram illustrating another example of an integrated image display (IID) illustrated in FIG. 1.

### DETAILED DESCRIPTION

Hereinafter, example embodiments will be described in detail with reference to the accompanying drawings.

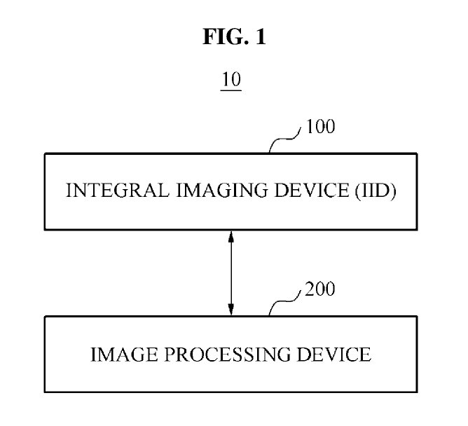

FIG. 1 is a diagram illustrating an example of a display system, according to an example embodiment.

Referring to FIG. 1, a display system 10 includes an integral imaging display (IID) 100 and an image processing device 200.

The display system 10 may include any one or more of an IID system, an eye three-dimensional (3D) display system, or an interactive system that provides interaction with a user (or a viewer). The display system 10 may be implemented as any of a personal computer (PC), a data server, or a portable device.

A portable device may be provided in any of a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or a portable navigation device (PND), a portable game console, or an e-book.

The IID 100 generates a 3D image based on an elemental image array (EIA) generated from the image processing device 200. For example, the IID 100 may be implemented as a tiled integral imaging display (T-IID) that combines a plurality of IIDs to form a 3D display of a large screen.

The image processing device 200 controls an overall operation of the display system 10. The image processing device 200 may be implemented as any of a system on chip (SoC), an integrated circuit (IC), or a printed circuit board (PCB), for example, a mother board. For example, the image processing device 200 may be an application processor.

The image processing device 200 generates the EIA and transmits the generated EIA to the IID 100.

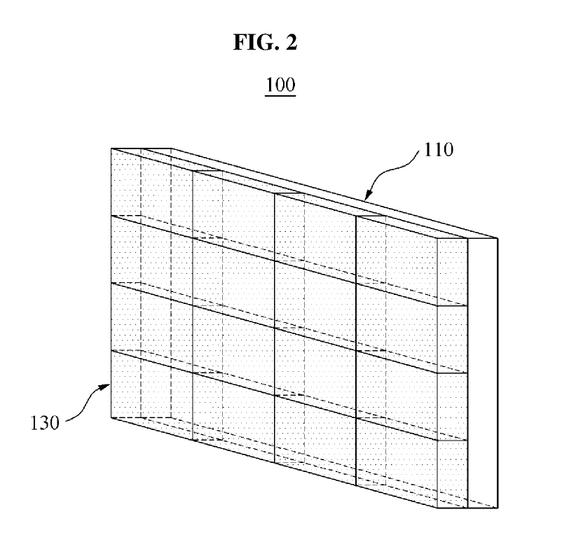

FIG. 2 is a diagram illustrating an example of the IID illustrated in FIG. 1.

Referring to FIGS. 1 and 2, the IID 100 includes a display panel 110 and a lens array 130.

The display panel 110 displays an EIA generated by the image processing device 200. The display panel 110 may be provided as a liquid crystal display (LCD) panel. Also, the display panel 110 may be provided as any of a touch screen panel, a thin-film-transistor liquid crystal display (FTF-LCD) panel, a liquid emitting diode (LED) display panel, an organic LED (OLED), an active-matrix OLED (AMOLED) display panel, or a flexible display panel. For example, the display panel 110 may be a two-dimensional (2D) display panel.

The display panel 110 includes a plurality of pixels. Each of the pixels includes a plurality of subpixels. Each of subpixels included in a pixel emits a light having a preset color in order to form a light of the pixel. As an example, each of the pixels may include a red subpixel, a green subpixel, and a blue subpixel. As another example, each of the pixels may further include a red subpixel, a green subpixel, a blue subpixel, and a white subpixel. The subpixels may include various subpixels, for example, different numbers of subpixels or different colors of subpixels, based on a display principle.

The lens array 130 generates a 3D image by refracting rays emitted from the EIA of the display panel 110. The lens array 130 may include any of a microlens array, a microprism array, or a lenticular lens array.

The lens array 130 is disposed in front of the display panel 110 and includes a plurality of lenses. A number of subpixels displayed by each of the lenses in a ray direction (i.e., in correspondence with a propagation direction of a ray with respect to each lens) may be less than a number of subpixels included in each pixel. Thus, a spatial resolution of the IID 100 may be enhanced while an angular resolution is also maintained by adjusting a parameter of a microlens and a distance between the microlens and a 2D display screen.

Each of the lenses displays, in the ray direction, a subset of subpixels included in a pixel. For example, each of N neighboring lenses displays, in the ray direction, a respective subset from among N subsets of the subpixels included in the pixel. “Neighboring” may indicate being adjacently positioned right next to each other or being positioned within a preset distance range. N is a natural number greater than “1”, and may be less than or equal to the number of the subpixels included in the pixel. Thus, each of N neighboring lenses displays a pixel in the ray direction. Concisely, each of N neighboring lenses displays 1/N neighboring pixels in the ray direction. The subpixels included in 1/N pixels may be included in a same pixel or in different pixels. When M is a number of the subpixels included in the pixel, each of N neighboring lenses displays M/N subpixels. M/N may be an integer or a fraction.

Each of N neighboring lenses displays 1/N neighboring subpixels included in a same pixel in the ray direction. For example, when N is equal to “2”, each of two neighboring lenses displays 50% of the subpixels included in the same pixel in the ray direction. When a pixel includes four subpixels, each of two lenses displays two subpixels in the ray direction.

Each of the lenses included in the lens array 130 has a same size. The number of the subpixels displayed, in the ray direction, by each of the lenses may be preset (or fixed).

As an example, the number of the subpixels displayed, in the ray direction, by each of the lenses may be less than a number of all subpixels included in the pixel. For example, when a number of subpixels included in a first pixel displayed, in a ray direction, by a first lens is less than a number of all subpixels included in the first pixel, at least one lens neighboring the first lens may display a subset of subpixels included in a second pixel neighboring the first pixel. It is assumed that there are two neighboring lenses (i.e., N=2), and the first pixel includes three subpixels. The first lens may display two subpixels included in the first pixel in a first ray direction. A second lens neighboring the first lens may display, in the first ray direction, a subpixel included in the second pixel neighboring the first pixel and remaining subpixels of the first pixel. For example, when each of the first pixel and the second pixel includes a red subpixel, a green subpixel, and a blue subpixel, and the first lens displays the red subpixel and the green subpixel of the first pixel in the first ray direction, the second lens may display the blue subpixel in the first ray direction. The neighboring first lens and the second lens may display, in the first ray direction, the red subpixel, the green subpixel, and the blue subpixel included in the first pixel. Thus, a viewer may view a pixel, that is, the first pixel, in the first ray direction through the neighboring first lens and the second lens.

Concisely, each of the lenses may display, in the ray direction, subpixels of which a number is less than a total number of the subpixels included in the pixel, in lieu of displaying all subpixels included in the pixel. A distance between the lenses formed based on an arrangement method of the lens array 130 may be decreased. In addition, a greater number of the lenses may be disposed in a display panel of the same size as the display panel 110. A 3D space resolution may be enhanced by performing denser sampling. A thickness of the IID 100 is determined based on a focal point of a lens included in the lens array 130, and the focal point of the lens is associated with the distance between the lenses formed based on the arrangement method of the lens array 130. The 3D space resolution may be enhanced and the thickness of the IID 100 may be reduced when the distance between the lenses formed based on the arrangement method of the lens array 130 is decreased to reduce the focal point of the lens and the display panel 110 is disposed within the preset range of a focal plane of the lens.

As another example, each of the lenses may display a subpixel in a ray direction. The viewer may view the subpixel through a lens when the viewer views the subpixel in the ray direction. In this example, the display panel 110 is disposed within the preset range of the focal plane of the lens. For example, the preset range is determined based on a condition in which each of the lenses displays a subpixel in a ray direction. The preset range is determined based on the display panel 110 and/or the lens array 130. The preset range is determined based on a test method. The display panel 110 is disposed on the focal plane of the lens. Colors of the subpixels displayed by each of N neighboring lenses included in the lens array 130 may correspond to a respective color of each of the subpixels included in the pixel. For example, when N is equal to “3”, and the pixel includes the red subpixel, the green subpixel, and the blue subpixel, the first lens displays the red subpixel, the second lens displays the green subpixel, and a third lens displays the blue subpixel, in the ray direction. The colors of the subpixels displayed by each of the first lens, the second lens, and the third lens are different, and may include red-green-blue (RGB). In this example, the first lens, the second lens, and the third lens are neighboring lenses. Thus, the viewer may view full color points or full color dots, for example, a full color image, through N, for example, three, neighboring lenses.

Each of the neighboring N lenses displays a pixel in a ray direction. For example, when the pixel includes the red subpixel, the green subpixel, and the blue subpixel, colors of subpixels displayed, in the ray direction, by three neighboring microlenses are different and colors of the displayed subpixels may include the RGB. Thus, the viewer may view a full color point or a full color dot through three neighboring microlenses. For example, rays emitted from the three neighboring microlenses are converged to form the full color point or the full color dot.

Hereinafter, for ease and convenience of description, it is assumed that each of lenses displays a subpixel in a ray direction. Descriptions of arrangements of lenses included in the lens array 130 based on various arrangement methods of subpixels are provided.

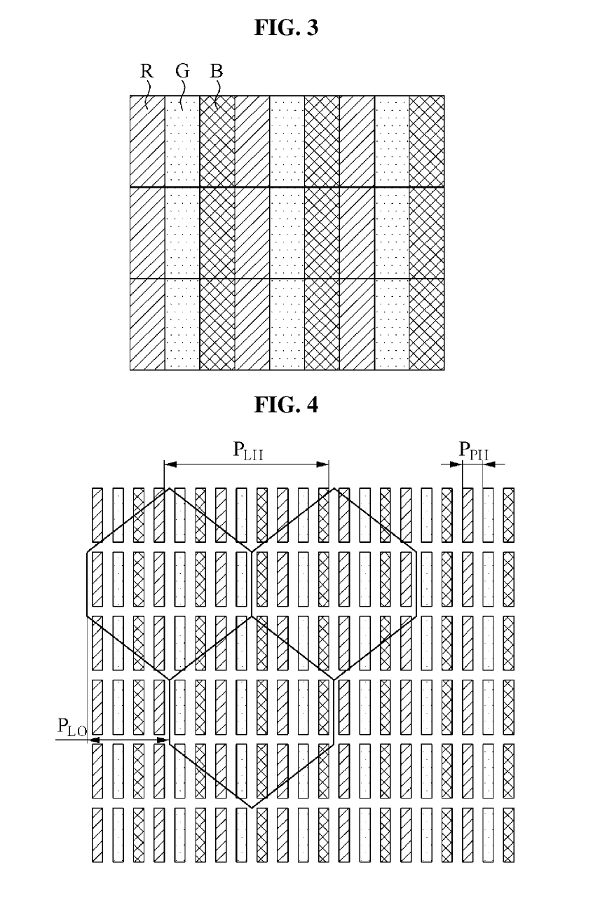

FIG. 3 is a diagram illustrating an example in which the subpixels of the display panel illustrated in FIG. 2 are arranged based on a standard red-green-blue (RGB) method.

Referring to FIG. 3, a plurality of subpixels included in each pixel may be arranged in a direction of a row. For example, the subpixels included in each pixel are arranged based on the standard RGB method as illustrated in FIG. 3. In this example, a red subpixel R, a green subpixel G, and a blue subpixel B may be arranged to form a pixel in the direction of the row. The lens array 130 may be obtained using Equations 1 through 6.

A distance P_{LH} between neighboring lenses in a same row may satisfy Equation 1, as expressed below.

0.4<(P_{LH}/P_{PH})%N<N−0.4 [Equation 1]

P_{PH} denotes a distance between neighboring subpixels in the same row, N denotes a number of subpixels included in a pixel, and % denotes modular calculation.

Also, the distance P_{LH} between the neighboring lenses in the same row may satisfy Equation 2, as expressed below.

(P_{LH}/P_{PH})%N=R1 [Equation 2]

where R1 is an integer, and may satisfy the following expression:

R1ε[1,N−1].

When the distance P_{LH} between the neighboring lenses in the same row satisfies Equation 1 and/or Equation 2, each of the neighboring lenses in the same row may display different subpixels in a ray direction. For example, colors of the different subpixels may be different.

In this aspect, lenses in two neighboring rows in the lens array 130 may be arranged based on an interlace method, or may be arranged in parallel. As an example, when the lenses in the two neighboring rows are arranged based on the interlace method, an offset may exist, in the direction of the row, between the lenses in two rows. The lenses in the two neighboring rows may not be aligned in a direction of a column. As another example, when the lenses in the two neighboring rows are arranged in parallel, the offset may not exist between the lenses in the two rows. The lenses in the two neighboring rows may be aligned in the direction of the column.

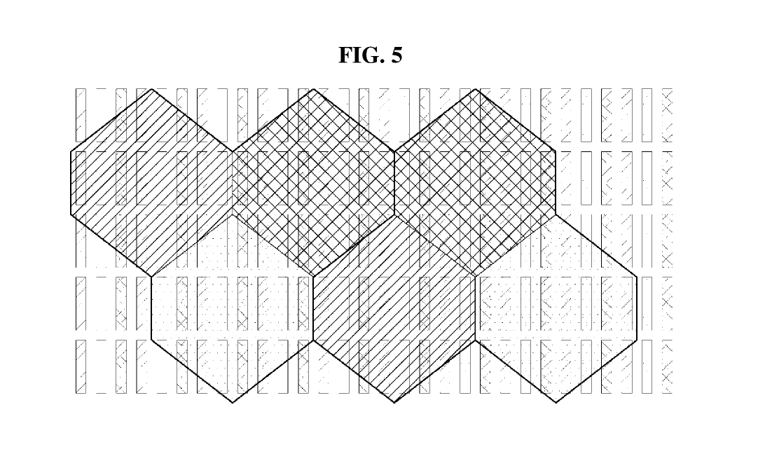

FIGS. 4 and 5 are diagrams illustrating examples in which the lenses included in the lens array illustrated in FIG. 2 are arranged based on an interlace method.

Referring to FIGS. 4 and 5, each lens may cover a plurality of subpixels, and an offset P_{LO} in a direction of a row may exist between lenses in each of two rows.

When lenses in the two neighboring rows are arranged based on an interlace method, the offset P_{LO} in the direction of the row between the lenses in each of the two rows may satisfy Equations 3 and 4, as expressed below.

0.4<(P_{LO}/P_{PH})%N<N−0.4 [Equation 3]

0.4<|((P_{LO}/P_{PH})%N)−((P_{LH}/P_{PH})%N)|<1.6 [Equation 4]

Also, the offset P_{LO} in the direction of the row between the lenses in each of the two rows may satisfy Equations 5 and 6, as expressed below.

(P_{LO}/P_{PH})%N=R1 [Equation 5]

|((P_{LO}/P_{PH})%N)−((P_{LH}/P_{PH})%N)|=1 [Equation 6]

When the offset P_{LO} in the direction of the row between the lenses in each of the two rows satisfies Equations 3 and 4 and/or Equations 5 and 6, each of the lenses in the two neighboring rows may display different subpixels in a ray direction.

Here, a distance P_{LV} between lenses in two neighboring rows may satisfy Equation 7, as expressed below.

0.1<((P_{LV}/P_{LH})%N)<10 [Equation 7]

As illustrated in FIG. 5, colors of subpixels which are displayed, in the ray direction, by three neighboring lenses based on an arrangement method of lenses included in the lens array 130 may be different. Concisely, a viewer may view a pixel through the neighboring three lenses. In FIGS. 4 and 5, a lens is hexagonal, but the shape of the lens is not limited thereto. The lens may have any of various shapes.

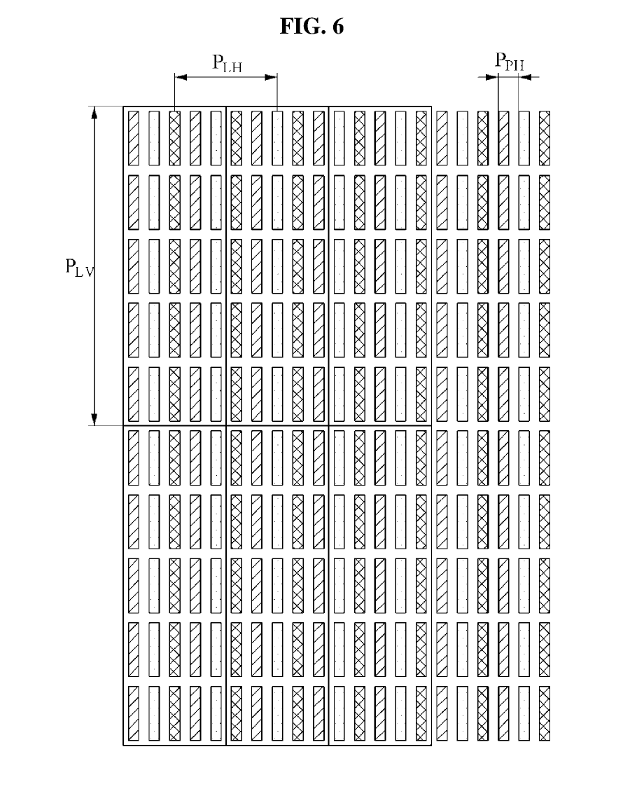

FIG. 6 is a diagram illustrating an example in which the lenses included in the lens array illustrated in FIG. 2 are arranged in parallel.

Referring to FIG. 6, each lens may cover a plurality of pixels, and an offset in a direction of a row may not exist between lenses in each of two rows. Concisely, the lenses in the two neighboring rows may be aligned in a direction of a column.

When the lenses in the two neighboring rows are arranged in parallel, the distance P_{LV} between the lenses in the two neighboring rows may satisfy Equation 8, as expressed below, in order to display a pixel through N consecutive lenses in the direction of the row.

1<(P_{LV}/P_{LH})<2N [Equation 8]

Also, the distance P_{LV} between microlenses in two neighboring rows may satisfy Equation 9, as expressed below.

(P_{LV}/P_{LH})=N [Equation 9]

In FIG. 6, a lens is rectangular, but the shape of the lens is not limited thereto. The lens may have any of various shapes.

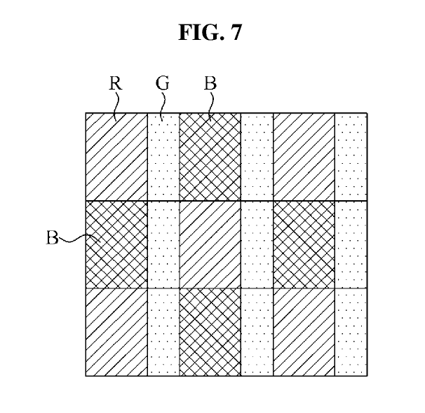

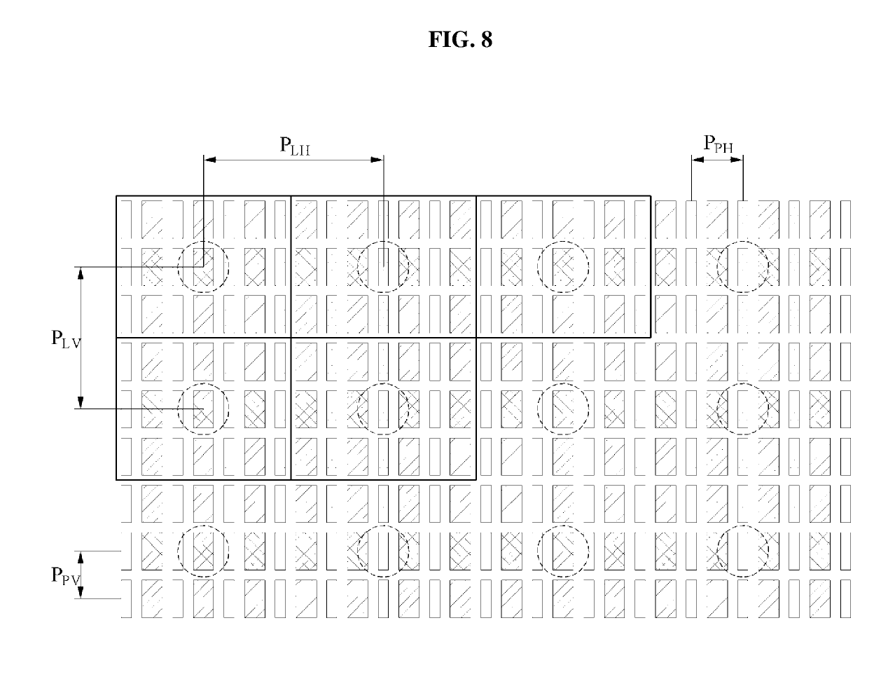

FIG. 7 is a diagram illustrating an example in which the subpixels of the display panel illustrated in FIG. 2 are arranged based on a standard PenTile method, and FIG. 8 is a diagram illustrating an example in which the lenses included in the lens array illustrated in FIG. 2 are arranged based on a standard PenTile method.

Referring to FIGS. 7 and 8, a plurality of subpixels included in each pixel may be arranged based on the standard PenTile method. A pixel may include a red subpixel R and a green subpixel G, or include a blue subpixel B and the green subpixel G. The lens array 130 may be obtained using Equations 10, 11, 12, and 13.

The distance P_{LH} between the neighboring lenses in the same row may satisfy Equation 10, as expressed below.

0.3<(P_{LH}/P_{PH})−Int(P_{LH}/P_{PH})<0.7 [Equation 10]

P_{PH} denotes a distance between neighboring green subpixels, for example, the green subpixel G, in the same row, and Int(P_{LH}/P_{PH}) indicates an integer of (P_{LH}/P_{PH}) (i.e., the greatest integer value that is less than (P_{LH}/P_{PH})).

Also, the distance P_{LH} between the neighboring lenses in the same row may satisfy Equation 11, as expressed below.

(P_{LH}/P_{PH})−Int(P_{LH}/P_{PH})=0.5 [Equation 11]

When the distance P_{LH} between the neighboring lenses in the same row satisfies Equation 10 and/or Equation 11, each of the neighboring lenses in the same row may display different subpixels in a ray direction. For example, respective colors of the different subpixels may be different.

Here, the distance P_{LV} between the lenses in the two neighboring rows may satisfy Equation 12, as expressed below.

0.4<((P_{LV}/P_{PV})%2)<1.6 [Equation 12]

P_{PV} denotes a distance between subpixels in the two neighboring rows.

Also, the distance P_{LV} between the lenses in the two neighboring rows may satisfy Equation 13, as expressed below.

((P_{LV}/P_{PV})%2)=1 [Equation 13]

When the distance P_{LV} between the lenses in the two neighboring rows satisfies Equation 12 and/or Equation 13, subpixels displayed, in the ray direction, by each of neighboring lenses in the same row may be arranged by intersecting the different subpixels, for example, the red subpixel R and the blue subpixel B.

Thus, the viewer may view a full color point, that is, a pixel, through neighboring lenses, for example, three lenses.

In FIG. 8, a lens is rectangular, but the shape of the lens is not limited thereto. The lens may have any of various shapes. Also, the lenses in the two neighboring rows are arranged in parallel, but the arrangement method of the lenses in the two neighboring rows is not limited thereto. For example, lenses in the two neighboring rows may be arranged based on an interlace method.

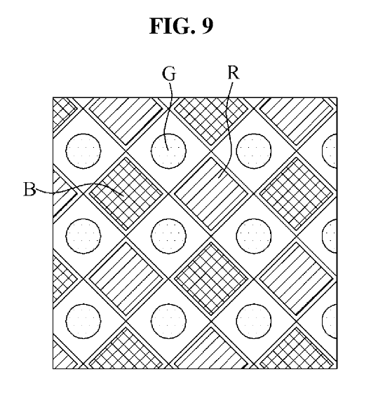

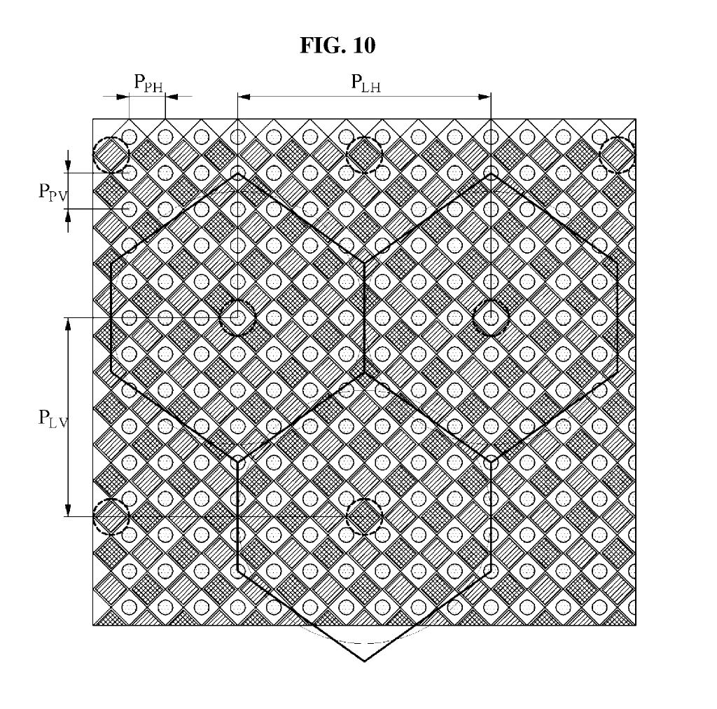

FIG. 9 is a diagram illustrating an example in which the subpixels of the display panel illustrated in FIG. 2 are arranged based on a diamond PenTile method. FIG. 10 is a diagram illustrating an example in which the lenses included in the lens array illustrated in FIG. 2 are arranged based on a diamond PenTile method.

Referring to FIGS. 9 and 10, subpixels included in each pixel are arranged based on the diamond PenTile method. The lens array 130 may be obtained using Equations 14, 15, 16, and 17.

The distance P_{LV} between the lenses in the two neighboring rows may satisfy Equation 14, as expressed below.

0.3<(P_{LV}/P_{PV})−Int(P_{LV}/P_{PV})<0.7 [Equation 14]

P_{PV} denotes a distance between subpixels in the two neighboring rows, and an Int(P_{LV}/P_{PV}) indicates an integer of (P_{LV}/P_{PV}) (i.e., the greatest integer value that is less than (P_{LV}/P_{PV})).

Also, the distance P_{LV} between the lenses in the two neighboring rows may satisfy Equation 15, as expressed below.

(P_{LV}/P_{PV})−Int(P_{LV}/P_{PV})=0.5 [Equation 15]

When the distance P_{LV} between the lenses in the two neighboring rows satisfies Equation 14 and/or Equation 15, each of neighboring lenses in different rows may display different subpixels in a ray direction.

The distance P_{LH} between the neighboring lenses in the same row may satisfy Equation 16, as expressed below.

0.4<((P_{LH}/P_{PH})%2)<1.6 [Equation 16]

P_{PH} denotes a distance between neighboring subpixels in the same row.

Also, the distance P_{LH} between the neighboring lenses in the same row may satisfy Equation 17, as expressed below.

((P_{LH}/P_{PH})%2)=1 [Equation 17]

When the distance P_{LH} between the neighboring lenses in the same row satisfies Equation 16 and/or Equation 17, subpixels displayed, in the ray direction, by each of the neighboring lenses in the same row may be arranged by intersecting the different subpixels, for example, a red subpixel R and a blue subpixel B.

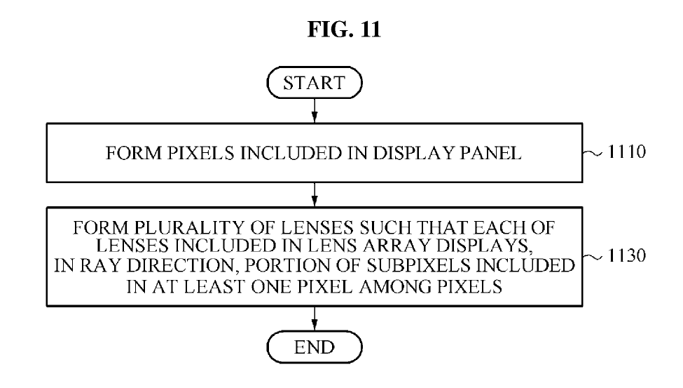

FIG. 11 is a flowchart illustrating an example of a method of manufacturing an integrated image display (IID) illustrated in FIG. 1.

Referring to FIG. 11, in operation 1110, pixels included in the display panel 110 are formed.

In operation 1130, a plurality of lenses is formed such that each of the lenses included in the lens array 130 displays, in a ray direction, a subset of subpixels included in at least one pixel among the pixels.

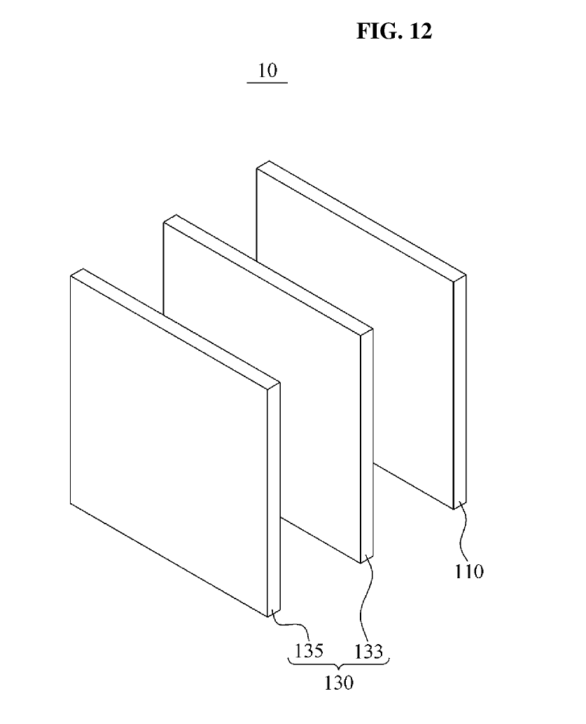

FIG. 12 is a diagram illustrating another example of the IID illustrated in FIG. 1.

Referring to FIG. 12, the IID 100 includes the display panel 110 and the lens array 130. The lens array 130 includes a first lens array 133 and a second lens array 135.

Each configuration and each operation of the display panel 110, the first lens array 133, and the second lens array 135 illustrated in FIG. 12 may be substantially the same as each configuration and each operation of the display panel 110 and the lens array 130 illustrated in FIG. 2.

The first lens array 133 is disposed in front of the display panel 110. The second lens array 135 is disposed in front of the first lens array 133. For example, the first lens array 133 is disposed between the second lens array 135 and the display panel 110.

Each of the first lens array 133 and the second lens array 135 includes a plurality of lenses. Shapes and arrangement methods of lenses included in the first lens array 133 and the second lens array 135 may be identical to those of FIGS. 3 through 10.

The shapes and the arrangement methods of the lenses included in the first lens array 133 may be identical to or different from the shapes and the arrangement methods of the lenses included in the second lens array 135.

For example, the second lens array 135 is rotated 90 degrees with respect to the first lens array 133. In this example, a distance between adjacent pairs of lenses included in the second lens array 135 is smaller than a corresponding distance between adjacent pairs of lenses included in the first lens array 133. Concisely, the second lens array 135 may be rotated 90 degrees in correspondence with a decreased ratio of the first lens array 133.

By adding the second lens array 135, the IID 100 may effectively decrease a black moiré pattern and may not excessively decrease a level of entire brightness.

Exemplary embodiments include transitory or non-transitory computer-readable media including program instructions to implement various operations embodied by a computer. The media may also include, alone or in combination with the program instructions, data files, data structures, tables, and the like. The media and program instructions may be those specially designed and constructed for the purposes of exemplary embodiments, or they may be of the kind well known and available to those having skill in the computer software arts. Examples of computer-readable media include magnetic media such as hard disks, floppy disks, and magnetic tape; optical media such as CD ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although a few exemplary embodiments have been shown and described, the present disclosure is not limited to the described exemplary embodiments. Instead, it will be appreciated by those of ordinary skill in the art that changes may be made to these exemplary embodiments without departing from the principles and spirit of the present inventive concept, the scope of which is defined by the claims and their equivalents.

1. An integrated image display (IID), the display comprising:
a display panel comprising pixels; and
a first lens array comprising a first plurality of lenses,
wherein each lens from among the first plurality of lenses is configured to display, in a ray direction, a subset of a plurality of subpixels included in at least one pixel from among the pixels.

2. The display of claim 1, wherein the each lens from among the first plurality of lenses is further configured to display, in the ray direction, at least one subpixel from among the plurality of subpixels.

3. The display of claim 2, wherein for a particular lens from among the first plurality of lenses, each of neighboring lenses is configured to display subpixels included in a pixel from among the pixels, and a number of the neighboring lenses is equal to a number of the subpixels included in the pixel.

4. The display of claim 1, wherein the display panel is disposed within a preset distance range of a focal plane of the lenses.

5. The display of claim 3, wherein respective colors of the subpixels displayed by each of the neighboring lenses are different.

6. The display of claim 1, wherein the plurality of subpixels is arranged based on a standard red-green-blue (RGB) method.

7. The display of claim 1, wherein the plurality of subpixels is arranged based on a standard PenTile method.

8. The display of claim 1, wherein the plurality of subpixels is arranged based on a diamond PenTile method.

9. The display of claim 6, wherein lenses in two neighboring rows among the first plurality of lenses are arranged based on an interlace method.

10. The display of claim 6, wherein lenses in two neighboring rows among the first plurality of lenses are arranged in a parallel arrangement.

11. The display of claim 3, wherein the neighboring lenses comprise at least one from among neighboring lenses in a same row or neighboring lenses in a different row.

12. The display of claim 1, further comprising:
a second lens array comprising a second plurality of lenses,
wherein the second lens array is disposed in front of the first lens array with respect to the display panel or disposed between the first lens array and the display panel, and the second lens array is configured to be rotated 90 degrees with respect to the first lens array.

13. The display of claim 12, wherein rays emitted from neighboring lenses among the first plurality of lenses are converged to form a full color dot.

14. The display of claim 13, wherein a distance between adjacent pairs of lenses included in the second lens array is smaller than a distance between adjacent pairs of lenses included in the first lens array.

15. A method for manufacturing an integrated image display (IID), the method comprising:
forming pixels included in a display panel; and
forming a plurality of lenses such that each of the lenses is included in a lens array and is configured to display, in a ray direction, a subset of a plurality of subpixels included in at least one pixel from among the pixels.

16. The method of claim 15, wherein each of the lenses is further configured to display, in the ray direction, a subpixel from among the plurality of subpixels.

17. The method of claim 16, wherein for a particular lens from among the first plurality of lenses, each of neighboring lenses is configured to display subpixels comprised in a pixel from among the pixels, and a number of the neighboring lenses is equal to a number of the subpixels included in the pixel.

18. The method of claim 17, wherein respective colors of the subpixels displayed by each of the neighboring lenses are different.

19. The method of claim 17, wherein the neighboring lenses comprise at least one from among neighboring lenses in a same row or neighboring lenses in a different row.
